(19) United States
(12) Patent Application Publication
(10) Pub. No.: US 2026/0112219 A1
(43) Pub. Date: Apr. 23, 2026

(54) METHOD FOR OPERATING AN ELECTROMECHANICAL LOCKING DEVICE

(71) Applicant: DORMAKABA SCHWEIZ AG, Wetzikon (CH)

(72) Inventors: Stephan HANSELMANN, Wetzikon (CH); Stefan GREIL, Wetzikon (CH); Tom MEIER, Wetzikon (CH); Tommy BLASER, Wetzikon (CH)

(21) Appl. No.: 19/121,311

(22) PCT Filed: Oct. 18, 2023
(86) PCT No.: PCT/EP2023/078908

§ 371 Date: Apr. 15, 2025

(30) Foreign Application Priority Data
Oct. 18, 2022 (EP) 22202296.4

(51) Int. Cl. G07C 9/00

(52) U.S. Cl. CPC G07C 9/00571; G07C 9/00309; G07C 9/00857; G07C 2009/00412; G07C 2009/00865

(57) ABSTRACT

The invention relates to a method (1, 85) for commissioning an electromechanical locking device (30) at a location (201-208), with the locking device (30) comprising an electromechanical actuator (35), locking device electronics (34) and a driver (36), with the electromechanical actuator (35) being able to be activated by the locking device electronics (34) in order to transfer the driver from a non-rotatable to a rotatable state;
and with the method (1, 85) comprising the following steps carried out by the locking device (30):
   a. detecting (82) an electronic key (20),
   b. triggering a function verification routine (83), with the actuator (35) being electrically activated in order to transfer the driver (36) from the non-rotatable to the rotatable state,
with the locking device (20) being in a factory state during steps a. and b.,
   c. subsequently receiving (124) configuration data, with the configuration data comprising at least one item of access authorisation information, whereby the locking device (30) is transferred from the factory state to a configured state.

### CROSS-REFERENCE TO RELATED APPLICATIONS

This application is a 35 U.S.C. § 371 National Stage patent application of PCT/EP2023/078908, filed on 18 Oct. 2023, which claims the benefit of European patent application no. 22202296.4, filed on 18 Oct. 2022, the disclosures of which are incorporated herein by reference in their entirety.

### TECHNICAL FIELD

The disclosure relates to a method for commissioning an electromechanical locking device at a location. Furthermore, the disclosure shows a system for commissioning the locking device at a location with which the method can be carried out.

### BACKGROUND

EP1914368 A2 as a prior art document discloses that a locking device activates an electromechanical actuator by means of locking device electronics. This is used to transfer a rotor into a rotatable state.

Keys that can be introduced into electromechanical locking devices and exchange data with the locking device are known from another prior art, for example EP 1 899 924 B1. If this results in an authorisation via the data exchange, the key can be rotated in the locking device.

However, the electromechanical device must first be commissioned. Usually in the prior art, the locking device is first assigned a corresponding authorisation during commissioning. The locking device is then brought to the location of the installation and inserted into a lock of a door.

### SUMMARY

The present disclosure provides a method for commissioning an electromechanical locking device at a location that can be carried out as efficiently as possible. Furthermore, the present disclosure provides a corresponding system for carrying out the method.

This is achieved by providing a method and system having the features of the independent claims. The dependent claims relate to various configurations of the disclosure. Features and details described in connection with the method according to the disclosure also apply in connection with the system according to the disclosure and vice versa. In particular, a method which can be carried out with a system and/or a system with which a method according to the claims can be carried out is protected.

The disclosure shows a method for commissioning an electromechanical locking device at a location. The electromechanical locking device is preferably a lock cylinder, in particular a double or half cylinder, a furniture cylinder or a padlock or similar device. The electromechanical locking device designed as a lock cylinder can be inserted into a lock (e.g. a mortise lock) on a door as a possible closure element. The padlock can be arranged on a door, for example. It is possible to arrange the locking device on or in various closure elements, e.g. on or in doors, gates, drawers, barriers.

The location of use of the locking device can be identified, in particular uniquely, via the “location”. It is preferably provided that, according to the method described below, a plurality of electromechanical locking devices are put into operation and the location is specific in such manner that it only applies to one of the locking devices put into operation and not to a plurality. The plurality of locking devices can be designed differently, for example partly as double cylinders, partly as padlocks or as double cylinders with different lengths.

The location may be a building and/or a cabinet, such as a switch cabinet, and/or a specific room within a building and/or a specific door, for example. Furthermore, the location can also be outside a building, for example when using the locking device on a door or gate of a fence or wall. Examples of a location are “Hotel room 308”, “Office 416”, “Switch cabinet Luisenstraße”, “Cellar building no. 1”, “Front door Amalienstraße 13”.

The locking device comprises locking device electronics. The locking device electronics preferably comprise a processor, for example a microprocessor, and/or an electronic data memory.

The locking device comprises an electromechanical actuator and a driver. The electromechanical actuator is activated during the method by the locking device electronics of the locking device in order to transfer the driver from a non-rotatable to a rotatable state.

The actuator can be designed as a solenoid or an electric motor, for example.

The driver is preferably rotationally asymmetrical and enables a closure element, in particular a door, to be unlocked or locked when rotated in the rotatable state.

For example, if the locking device is designed as a lock cylinder and inserted into a corresponding lock, the driver can move, for example, the latch or bolt in the lock. For example, the driver can correspond to a locking lug of a lock cylinder. In another example, the driver can comprise recesses in which locking elements can slide in order to unlock the shackle of a padlock.

The electromechanical actuator, in turn, enables the driver to be transferred to the rotatable state when appropriately activated by the locking device electronics. Unlocking or coupling can take place for this purpose. In particular, the locking device can comprise a housing in which a rotor is at least indirectly rotatably supported. The actuator can be used to unlock the previously locked rotor such that the rotor and the driver connected to the rotor are rotatable. Additionally or alternatively, the rotor can be coupled to the driver by means of the actuator, allowing the driver to rotate with the rotor. The decoupled and/or locked state of the driver is referred to as the non-rotatable state. The coupled and/or unlocked state of the driver is referred to as the rotatable state.

During operation of the locking device, this occurs in particular depending on whether an access authorisation verification could be successfully completed in the system, e.g. whether the access authorisation information stored in the locking device matches the corresponding access authorisation information of the introduced key.

It is preferably provided that a unique electronic identifier is assigned to the locking device and this identifier is stored in the locking device, preferably in the locking device electronics, in particular on a microchip. The identifier is, for example, a character string stored in the locking device.

Additionally or alternatively, it may be that the key comprises a unique electronic key identifier. This is stored in the electronics of the key.

The method comprises at least the following steps. These steps are carried out by the locking device:
a. detecting an electronic key,
b. triggering a function verification routine, with the actuator being electrically activated in order to transfer the driver from the non-rotatable to the rotatable state,
   with the locking device being in a factory state during steps a. and b.,
c. subsequently receiving configuration data, with the configuration data comprising at least one item of access authorisation information, whereby the locking device is transferred from the factory state to a configured state.

Step a. can preferably be carried out by the locking device electronics. Detection can take place by the locking device receiving electrical energy from the key. Additionally or alternatively, the locking device electronics can receive electronic data from the key.

Step b. can preferably be carried out by the locking device electronics.

Subsequent to step b., it is in particular provided that the driver is rotated by means of the key. This is carried out manually, in particular by an installer. This gives the installer the certainty that the locking device can be operated properly electromechanically.

According to the disclosure, the locking device is in a factory state during steps a. and b. In the factory state, at least some of the configuration data is missing, preferably all configuration data that is provided in the operation to prevent access by unauthorised persons. This means that the transition from the factory state to the configured state stores electronic configuration data in the locking device, which prevents unauthorised persons from gaining access.

Preventing access is understood to mean, for example, if the locking device receives an opening command from the key but is unable to decrypt this opening command. For example, the key has previously verified the access authorisation, e.g. on the basis of the identifier. Preventing access means, for example, additionally or alternatively, that the locking device verifies the access authorisation, e.g. on the basis of the key identifier, on the basis of a list of blocked authorisations, the so-called blacklist.

The access authorisation information received in step c. is therefore information that limits the activation of the actuator in order to transfer the driver from the non-rotatable to the rotatable state. This reduces the number of keys used to activate the actuator in order to transfer the driver from the non-rotatable to the rotatable state.

Thus, according to the disclosure, it is provided that an installer can first verify the electromechanical function of the locking device by means of steps a. and b., before the configuration data makes it difficult or impossible for the installer to verify the electromechanical function of the locking device after step c. The fact that the installer initially has the locking device in its factory state makes it easy to verify the electromechanical function of the locking device. This means that the installer does not need to have different keys with different access authorisations ready in order to verify the electromechanical function of different locking devices one after the other. Instead, one key is sufficient. This makes the commissioning process more efficient. If a locking device is not sufficiently functional electromechanically, it can be replaced without having to transfer access authorisation information from the non-functional locking device to the functional locking device.

Preferably, the access authorisation information is received by the locking device for the first time in step c. This is therefore not an update of the access authorisation information.

The configuration data is preferably stored in the data memory.

It may be that the configuration data corresponds to the access authorisation information.

It is preferably provided the locking device is rotatable with any key in the factory state. In particular, it is provided that any key comprises no access authorisation or a very generally valid access authorisation or very generally valid access authorisation information that is accepted by the locking device. Any key means a key that is compatible in a number of locking devices comprising the same mechanical inner structure. This allows the keys to match the locking element structurally. For example, these keys can be geometrically insertable into and removable from the lock channel, have appropriate electrical contacts for electrical contacting of the corresponding contacts of the locking device or the like. The fact that the driver is preferably rotatable by any key before step c. makes it possible to first effectively verify the electromechanical functioning of the locking device.

The configuration according to the disclosure enables the installer in particular to take along and/or install locking devices in the factory state at different locations without having to pay attention to access authorisation information.

Preferably, the locking device is mounted at the location in the factory state. This means that the mechanical mounting of the locking device can take place first, before step c. takes place. This means that mounting takes place before access for the installer is restricted or prevented by the configuration data. Particularly preferably, step b. takes place at least partially after installation of the locking device in or on a closure element, in particular a door. This allows the installer not only to test the locking device electromechanically, but also to verify whether the closure element can be properly unlocked when the driver is in the mounted state, e.g. whether the door can be unlocked with the lock with little friction by rotating the driver.

Additionally or alternatively, step b. takes place at least partially in order to install the locking device on a closure element. In particular, it can be provided that the driver, in particular the locking lug, is rotated into a position in which the locking device can be inserted into the closure element. Alternatively, the shackle of a padlock is unlocked to attach the padlock to the closure element. This means that a necessary mounting step can also be used to verify the electromechanical functionality of the locking device.

It is also conceivable to carry out step b before and after mounting.

Preferably, in step b. the function verification routine is triggered independently of a lock system assignment of the locking device.

In the configured state, the locking device is assigned to a lock system.

Within the lock system there are located a plurality of the locking devices, which are put into operation in particular according to the method described here. The lock system also provides for a specific access authorisation concept. For example, a plurality of individuals authorised for access can be assigned to the lock system, with one or a plurality of the locking devices being assigned to each individual authorised for access as being authorised for access.

The individuals authorised for access can be divided into authorisation groups. For example, the lock system can relate to a block of flats. An authorisation group can be intended for the caretaker, who may lock all locking devices with the exception of the locking devices on the individual flats. Another authorisation group can be provided for flat owners, who may, for example, lock the locking devices on the front door and their own flat.

It is preferably provided that the lock system comprises a plurality of locking devices that are assigned, and in particular belong, to an owner, e.g. a housing association.

A lock system is additionally or alternatively preferably characterised in that the lock system comprises at least one list of blocked lock authorisations, which is referred to as a blacklist. The blocked lock authorisations can relate to one or a plurality of locking devices of the lock system. At least one blacklist is preferably limited to a single lock system. In other words, different lock systems are distinguished by having their own blacklists.

The lock system can additionally or alternatively be characterised in that the lock system has its own encryption information, e.g. its own encryption key and/or its own encryption algorithm. The encryption information can also be referred to as cryptographic information and/or the encryption key as a cryptographic key. This means that different lock systems preferably differ in terms of encryption information.

Because step b. is carried out independently of a lock system assignment, an installer can verify the electromechanical functionality of locking devices of different lock systems one after the other with just one key. In particular, the installer can mount locking devices of different lock systems at different locations one after the other with just one key, with the installer having to rotate the driver in particular for mounting.

In step b., the function verification routine is preferably triggered independently of a location region assignment of the locking device. A location region—for example a part of a building with a plurality of doors—thus preferably relates to a plurality of locking devices, with the locking devices being arranged in the location region. The locking devices of a location region are preferably part of a single lock system. The lock system can comprise locking devices of a plurality of location regions. For example, the lock system comprises the locking devices of a building and the location regions each comprise one floor of the building. The location region preferably comprises a plurality of locations where locking devices are installed.

Because step b. is carried out independently of a location region assignment, an installer can verify the electromechanical functionality of locking devices of different location regions one after the other with just one key. The installer can in particular mount locking devices of different location regions at different locations one after the other with just one key, with the installer having to rotate the driver in particular for mounting.

In step b., the function verification routine is preferably triggered independently of a location assignment of the locking device. Exactly one locking device is preferably assigned to a location. Because step b. is carried out independently of a location assignment, an installer can verify the electromechanical functionality of a plurality of locking devices one after the other just one key. The installer can in particular mount locking devices at different locations one after the other with just one key, with the installer having to rotate the driver in particular for mounting.

The key preferably comprises a key shank. The key shank can be introduced into the locking device, preferably into a lock channel of the locking device. The key and key shank are preferably designed such that a torque can be transmitted to the locking device with the key via the key shank. The mechanical movement of the locking device is therefore preferably carried out with the key.

It is preferably provided that the key establishes an electrical connection to the locking device, in particular via the key shank. The connection can be wireless or wired. The key and the locking device comprise corresponding transmission devices. “Wired” (also referred to as non-wireless) means that the connection takes place via at least one conductor in the key that can be brought into contact with the locking device electronics in an electrically-conductive manner. For this purpose, the key and the locking device can comprise corresponding electrical contacts as transmission devices.

The connection can be used to transmit data, in particular the identifier. The electrical connection makes it possible to exchange data, in particular non-wirelessly, between the key and the locking device. Alternatively or additionally, the transmission devices can be used to transmit electrical energy (also known as power) from the key to the locking device.

The function verification routine is preferably triggered in step b. by means of a key that structurally matches the locking device. For example, the key structurally matching the locking device can be geometrically insertable into and removable from the lock channel. Additionally or alternatively, the key structurally matching the locking device has a transmission device matching the transmission device of the locking device.

It is in particular provided that the same key can unlock all structurally matching electromechanical locking devices of a manufacturer in the factory state by means of a general encryption key or without an encryption key.

The key used in step a. is in particular configured in such manner that drivers of locking devices that are in the configured state can be transferred to the rotatable state by means of an access authorisation. This means that the same key can be used by the installer to verify the electromechanical functionality of locking devices in the factory state and/or to fasten them in or on a closure element in the factory state and to gain access to a locked room when the locking devices are in operation. This depends, in particular exclusively, on the electronic data of the key.

This means that access authorisations for locking devices that are in the configured state can be present on the same key. For example, the installer also works as a caretaker. In this capacity, the installer can install the locking devices in the factory state and use the same key to operate the already configured locking device on the caretaker's flat once the work has been completed. Additionally or alternatively, after step c. as part of the commissioning process, an at least one-time access authorisation can be present on the key in order to verify access with authorisation.

It may be that in the configured state of the locking device, the locking device electronics only activate the actuator in order to transfer the driver to the rotatable state if the access authorisation has been verified beforehand. The access authorisation verification takes place in the system, in particular in the key and/or in the locking device. Access authorisation can be determined in particular by means of the electronic identifier of the keys and/or the key identifier. As part of the access authorisation verification, for example, the key can send the key identifier to the locking device and/or the locking device can send the identifier to the key.

For example, it can be provided that the electronic key determines the access authorisation on the basis of the electronic identifier of the locking device and sends an opening command to the locking device. Additionally or alternatively, it may be that the key selects access authorisation information on the basis of the electronic identifier and sends the selected access authorisation information to the locking device for verification. Additionally or alternatively, it may be that the locking device verifies the access authorisation of the key identifier, in particular on the basis of a whitelist and/or a blacklist. The location can also be verified in the key, for example. Furthermore, it can be provided that either the key and/or the locking device verify a timed access condition.

It is in particular provided that step b. takes place without an access authorisation, which depends on the electronic identifier of the locking device, having been verified beforehand. Additionally or alternatively, it is provided that step b. takes place without an access authorisation, which depends on the key identifier of the locking device, having been verified beforehand. Additionally or alternatively, it is provided that step b. takes place without an access authorisation, which depends on the location, having been verified beforehand. It is therefore preferably provided that the usual access authorisation verification, which takes place in the configured state of the locking device, does not take place in the factory state.

Step b. preferably takes place without an access authorisation, which depends on an electronic identifier (ID) of the locking device or the electronic key identifier, having been verified beforehand. Step b. particularly preferably takes place without an access authorisation, which depends on an electronic identifier (ID) of the locking device, the electronic key identifier or the location, having been verified beforehand. The fact that the activation of the actuator to move the driver into the rotatable state does not depend on the identifier, the key identifier and the location in the factory state preferably prevents an access authorisation that depends on the key, the locking device and the location from being verified.

The aforementioned specifications of step b. preferably characterise the factory state of the locking device. In the factory state, the locking device can therefore preferably trigger the function verification routine independently of a lock system assignment, a location region assignment and/or a location assignment. Additionally or alternatively, the locking device in the factory state can trigger the function verification routine independently of an access authorisation verification, which depends on the identifier, the key identifier and/or the location.

In step b., the locking device for energising the actuator is preferably supplied by an electrical energy storage device of the key, with the key comprising the key shank for introduction into the locking device and for transmission of electrical energy to the locking device. The key shank must preferably be introduced into the locking device to detect the key in step a. This makes it in particular possible for the corresponding transmission devices to be connected.

It is preferably provided that the access authorisation information in step c. comprises location-specific access authorisation information. This means that access authorisation information is received that is specific to the location. The location-specific authorisation information relates to a specific location and therefore preferably to exactly one locking device. In the factory state, however, the locking device is preferably free of location-specific access authorisation information. Steps a. and b. are preferably carried out without the locking device having previously been electronically assigned to a location.

Additionally or alternatively, it is provided that access authorisation information in step c. comprises location region-specific access authorisation information. This means that access authorisation information is received that is specific to the location region, in particular is valid for the entire location region. The location region-specific authorisation information relates to a specific location region—for example a part of a building with a plurality of doors—and therefore preferably to a plurality of locking devices. In the factory state, however, the locking device is preferably free of location region-specific access authorisation information. Steps a. and b. are preferably carried out without the locking device having been electronically assigned to a location region beforehand.

Additionally or alternatively, it is provided that access authorisation information in step c. comprises lock system-specific access authorisation information. This means that access authorisation information is received that is specific to the lock system, in particular is valid for the entire lock system. The lock system-specific access authorisation information refers to a lock system as previously defined. The lock-specific access authorisation information relates to a plurality of locking devices. In the factory state, however, the locking device is preferably free of lock system-specific access authorisation information. Steps a. and b. are preferably carried out without the locking device having been electronically assigned to a lock system.

The access authorisation information can comprise at least one blacklist, encryption information, in particular an encryption key, and/or locking device operating data.

The blacklist comprises a list of blocked access authorisations, in particular blocked key identifiers. The encryption information, in particular the encryption key, is used for the electronic decryption of electronic data received by the locking device. The encryption information can therefore also be referred to as cryptographic information and/or the encryption key as a cryptographic key. The locking device operating data comprises data on the operation of the locking device, for example, a period of time during which the actuator is energised to transfer the driver to the rotatable state and/or data relating to an audible and/or visual indication of a state of the locking device. In particular in the case of an electromechanical coupling between the rotor and the driver, the locking device operating data can comprise a period of time until the actuator is activated to return to the non-rotatable state.

It is therefore preferably provided that the access authorisation information contains a location-specific and/or location region-specific and/or lock system-specific blacklist. For example, the blacklist comprises blocked authorisations that are blocked for the entire lock system and blocked authorisations that are only blocked for the location. The blacklist can therefore be specific to the lock system and location. The locking device in steps a. and b. is preferably free of a location-specific and/or location region-specific and/or lock system-specific blacklist. The locking device is preferably free of a location-specific and/or location region-specific and/or lock system-specific blacklist in the factory state.

Additionally or alternatively, it is preferably provided that the access authorisation information contains location-specific and/or location region-specific and/or lock system-specific encryption information, in particular a location-specific and/or location region-specific and/or lock system-specific encryption key. The locking device in steps a. and b. is preferably free of location-specific and/or location region-specific and/or lock system-specific encryption information, in particular encryption keys. In the factory state, the locking device is preferably free of location-specific and/or location region-specific and/or lock system-specific encryption information, in particular encryption keys.

The encryption information can be composed of different items of information. For example, the encryption information comprises information that is specific to the entire lock system and information that is specific to the location only. This means that the encryption information can be specific to the location and lock system. Since exactly one locking device is assigned to a location, location-specific encryption information is also to be understood as encryption information that is specific to the identifier.

Additionally or alternatively, it is preferably provided that the configuration data contains location-specific and/or location region-specific and/or lock system-specific locking device operating data. The locking device in steps a. and b. is preferably free of location-specific and/or location region-specific and/or lock system-specific locking device operating data.

It is preferably provided that a location-specific user input for defining the location is provided by receiving the user input by way of a, in particular mobile, device before step c. Thus, the method according to the disclosure can also involve method steps that are not carried out by the locking device. Rather, the method step of receiving the user input is carried out by the device.

The location-specific user input is preferably received after steps a. and b. The locking device is in the factory state during receipt.

The device is preferably a mobile device, in particular a smartphone, tablet or laptop. Alternatively, the device can also be a terminal that is mounted in or on the building, for example on the wall, and is used for room and/or building control. It is preferably provided that the device can establish a connection to the Internet and/or a telecommunications network. The device can preferably communicate with a computing unit via the Internet or the telecommunications network.

The computing unit can be located anywhere. It is in particular provided that the device communicates wirelessly with the computing unit, in particular via the Internet or a telecommunications network. The computing unit can be a server, for example. The server can also be provided virtually, in particular as a cloud service. In particular, a corresponding database is stored in the computing unit.

The device preferably has input means; for example, a keyboard and/or a touchscreen. The input means are used in particular to allow the user, in particular the installer, to enter the location into the device. The device also preferably has output means, for example a screen, in particular a touchscreen, and/or a loudspeaker. The device preferably comprises electronics. The electronics are used in particular to process the user input and/or to output a message on the output means.

As described, the device “receives” the location-specific user input, which also means that the user input can take place by way of an external input device, such as a keyboard connected wirelessly to the device. However, it is particularly preferably provided that the location-specific user input is performed on the device, i.e. the input means is located directly on the device, for example the touchscreen or the keyboard of the device. The installer in particular performs the input manually on the input means, in particular on the screen. In one example, the location-specific user input is entered by the user, in particular the installer, on the touchscreen of the smartphone or tablet.

The location-specific user input refers in particular to a user input of the location or a selection of the location, such that the information about the location, hereinafter referred to as location information, is present in the device. Examples of a user input of the location are “Hotel room 308”, “Office 416”, “Switch cabinet Luisenstraße”, “Cellar building no. 1”, “Front door Amalienstraße 13” or an input on a two-or three-dimensional location overview plan.

This user input particularly preferably takes place while the user, in particular the installer, is on site, i.e. at the location defined here. It is in particular provided that this receipt of the location-specific user input on the device only takes place when the installer is on site together with the locking device to be installed. The installer does not have to stand directly in front of the closure element in which the locking device is installed, in particular if the location is in an explosion-protected area or if no mobile phone reception is possible directly at the location.

It may be that the key is designed for wireless communication with the device. Wireless communication with the device takes place in particular via active, wireless sending of the key. Near-field communication, for example via Bluetooth or ultra-wideband (UWB), is in particular used. The key preferably comprises electronics. The electronics can be used to carry out communication.

It is preferably provided that the key identifier is sent from the key to the device after communication has been established between the key and the device. The device preferably sends the key identifier on to the computing unit. This allows the computing unit to verify, for example, which usage rights the key has and/or are to be assigned to the key. The device can also send further data specifically to this one key only.

The method step of defining the location at which the locking device is installed by a user input on the device serves to prepare for step c. The location information at which the locking device is installed makes it possible to receive location-specific access authorisation information from the locking device. If the location is already assigned to a location region and/or a lock system, e.g. in the computing unit and/or the device, the location information can be used to enable location region- and/or lock region-specific access authorisation information to be received in step c. This makes it easily possible for the installer to select any locking device in the factory state on site as part of the commissioning method and then transfer it to the configured state.

In addition or as an alternative to determining the location, a lock system selection of a lock system can take place by receiving a lock system user input by way of the, in particular mobile, device before step c. This allows the user, in particular the installer, to select an appropriate lock system, in particular before the location-specific user input. The lock system is preferably selected manually. The user input takes place in particular by way of the input means. The installer can in particular select the lock system by way of a manual input on the input means. For example, the user, in particular the installer, enters the lock system on the touchscreen. In particular, by defining the lock system via a user input on the device, lock system-specific access authorisation information can be received by the locking device in step c.

The lock system-specific user input is preferably received after steps a. and b. The locking device is in the factory state during the input.

The location-specific user input and/or lock system user input is/are preferably carried out by selecting from selection lists and/or overview plans displayed on a screen of the device. Alternatively or additionally, it can be provided that the location information is newly created during the location-specific user input.

The following is in particular provided for the location-specific user input for defining the location, i.e. the input of the location information:

The location-specific user input can take place by selecting a location from a selection list. The selection list is preferably displayed on the screen of the device. This selection list is in particular sent to the device by a computing unit. Or the device receives the selection list from the computing unit. The user, in particular the installer, can select the appropriate location on the device while they are in particular on site to carry out commissioning.

Additionally or alternatively it is provided that the location-specific user input preferably takes place or is supplemented by a free text input. This free text input takes place in particular on the device. This can be used to newly create location information.

In addition, the location-specific user input can also take place or be completed by selection on a location overview plan. This location overview plan is preferably sent from the computing unit to the device. Or the device receives the location overview plan from the computing unit.

The selection in particular takes place on the location overview plan on the device. The location overview plan can, for example, be a room overview plan that graphically represents the position of rooms within a building, such that the location is selected by clicking on a specific room or door, for example, which results in the location-specific user input. In a very similar way, the location overview plan can be a building overview plan on which the installer selects a specific building in which to install the locking device. Furthermore, the location overview plan can also represent the various locations on a map, for example locations in the form of buildings or switch cabinets that are arranged widely distributed.

It is conceivable that the user, in particular the installer, newly creates location information. This means that the installer generates location information through the user input before this generated location information has been stored in the computing unit. This allows a location to be taken into account as the installation location of the locking device that is not stored as such in the computing unit. In this way, the user creates location information. This is conceivable in particular by way of the free text input or by the selection on the location overview plan.

The individual location-specific user input can also take place using a combination of a plurality of different or identical methods described above. For example, a location can first be selected from the selection list and supplemented with a text input. In a similar way, for example, a building can first be selected in the location overview plan and then the specific location can be defined in a more detailed location overview plan or via a free text input or via the selection list.

The lock system is preferably selected from a predefined selection list. The user, in particular the installer on site, preferably cannot newly create a lock system. It is preferably provided that the lock system selection is taken into account during the location-specific user input. For this purpose, the device can electronically store possible locations associated with the lock system for at least one lock system.

The location-specific user input for defining the location preferably takes place first by way of the lock system selection and a subsequent selection of the location in the lock system. In particular, a selection list of locations is provided for this purpose, which only shows locations of the selected lock system. Additionally or alternatively, a free text input of the location takes place after the lock system selection. In particular, it is also possible to create new location information within a lock system. It is also possible that after the lock system selection, a subsequent selection of the location takes place using a location overview plan of the lock system. This location overview plan has already been described above. It can preferably be provided that only locations of the respective lock system are displayed on the location overview plan.

In preparation for step c., for example, the computing unit and/or the device can use the location information to infer the location region in which the location where the locking device is installed is located in the location region on the location overview plan. Alternatively, as already mentioned, possible locations are assigned to location regions in the computing unit and/or the device before the user input.

After the location-specific user input has been received by the device, the identifier (ID) is preferably assigned to the defined location to form an ID location assignment. The ID location assignment can, for example, be a dataset in which the appropriate location is listed for the ID. However, it is also regarded as an “ID location assignment” if, for example, the ID and the location are stored in different tables and only the link between the ID and the location is saved. It is particularly preferably provided that the assignment takes place for the first time, which means that the specific identifier of the locking device is assigned to a location for the first time. Alternatively, the assignment takes place after prior deletion of an existing ID location assignment, but an assignment is preferably not possible as long as an assignment exists for the current ID.

Once the lock system has been selected, the selected lock system is preferably assigned to the identifier of the locking device to form an ID lock system assignment.

The ID location assignment and/or the ID lock system assignment preferably takes place in the device. For this purpose, the locking device can send the identifier to the device, in particular via the key.

The key is particularly preferably introduced with its key shank in the locking device while the locking device sends the identifier to the key. The key being introduced in the locking device can be a prerequisite for the locking device sending the identifier to the key. The key being introduced in the locking device can be a prerequisite for the key receiving the identifier from the locking device.

It may be that the key is introduced in the locking device with the key shank while the key relays the identifier to the device. The key being introduced in the locking device can be a prerequisite for the key sending the identifier to the device. The key being introduced in the locking device can be a prerequisite for the device receiving the identifier from the key.

The following method step is preferably provided: electronically sending the identifier (ID) by way of the locking device to the computing unit before step c, in particular via the key and/or the device. The identifier of the locking device is preferably sent indirectly to the device by way of the locking device. It is in particular provided that the locking device first sends the identifier to the key, in particular non-wirelessly. The key then relays the identifier of the locking device to the device, in particular wirelessly via near-field communication. Sending the identifier is used to set up or supplement the database in the computing unit. The identifier is preferably sent after the ID location assignment and/or the ID lock system assignment has been formed.

It is preferably provided that, in particular before step c., the device sends the location information obtained by the location-specific user input and/or the lock system information obtained by the lock system user input to the computing unit. The location information and/or lock system information is preferably sent after the ID location assignment and/or the ID lock system assignment has been formed.

It can be provided that the device receives from the computing unit access authorisation information, in particular location-specific, location region-specific and/or lock system-specific access authorisation information. The access authorisation information received by the device may be identical to the access authorisation information in step c. or may differ therefrom. For example, the access authorisation information received from the computing unit is modified in the device and/or key. The receipt of the access authorisation information by the device is used to prepare for step c. This method step is carried out by the device. This method step takes place in particular after the method step of sending the location-specific and/or lock system-specific user input. The computing unit can in particular use the location information and/or lock system information to send the appropriate access authorisation information to the device.

It is preferably provided that the access authorisation information, in particular location-specific and/or location region-specific and/or lock system-specific access authorisation information, is sent from the key to the locking device. The commissioning method can therefore also comprise a step that is carried out by the key. This is the access authorisation information that is received by the locking device in step c.

To send the access authorisation information, the key comprises the key shank, with the key being introduced into the locking device with the key shank in order to send the, in particular location-specific and/or location region-specific and/or lock system-specific access authorisation information, to the locking device.

It can be provided that the key has previously received access authorisation information, in particular location-specific, location region-specific and/or lock system-specific access authorisation information from the device. The access authorisation information is particularly preferably sent from the computing unit to the device and from the device to the key. Step c. then takes place, i.e. the access authorisation information is sent from the key to the locking device or received by the locking device. Between the receipt of access authorisation information by the key and the sending of the access authorisation information to the locking device, it can be provided that the key modifies the access authorisation information, in particular the encryption information.

It is preferably provided that in step c. the access authorisation information, in particular location-specific and/or location region-specific and/or lock system-specific access authorisation information, is sent from the key to the locking device.

It can be provided that the key in step a. is a first key. The key for sending the access authorisation information for step c. can be a second key. This means that at least two keys are used. This makes it possible for a first installer to test only the electromechanical functionality and thus have steps a. and b. carried out by the locking device. The first installer in particular introduces the first key into the locking device. Furthermore, the first installer may be responsible for mounting the locking device on or in the locking element. As already described, the first installer can also carry out steps a. and b. for this purpose. It is preferably not necessary for the first installer to make a user input into the device.

A second installer may be responsible for having step c. carried out by the locking device. The installer preferably introduces the second key into the locking device. The second installer is responsible in particular for making a user input into the device, in particular to define the location and/or the lock system. This allows the method to be configured more effectively, as the first and second installers each carry out different subtasks specific to them.

The first key and the second key can have an identical mechanical design.

The first and second keys preferably comprise different authorisations. Thus, for example, the first installer may not even be authorised to have step c. performed by the locking device and/or to perform preparatory steps for carrying out step c. The first installer is in particular not authorised to carry out a user input to define the location and/or the lock system in the device.

After step c., i.e. in the configured state, the actuator is preferably only activated in order to transfer the driver to the rotatable state if the location-specific, location region-specific and/or lock system-specific access authorisation has been verified beforehand.

It is preferably provided that, after step c., the method comprises the following further step, which is carried out by the locking device and/or the key:
d. Denying the access authorisation for the key that sent the access authorisation information to the locking device in order to verify the function of the locking device in the configured state.

The key is preferably the second key. By subsequently denying the access authorisation, the installer, in particular the second installer, can verify whether the access authorisation information was received by the locking device in step c. and is now also used to deny access authorisations. It is preferably the same key that sent the access authorisation information. This allows the, in particular second, installer to verify the successful commissioning with the same key that was previously used in step c.

It may be for example that the key itself carries out the verification. The access authorisation can, for example, not depend on the key, in particular on the key identifier, but on the authorisations stored on the key, which can be verified using the identifier, for example.

It is preferably provided that, after the locking device has received the access authorisation information, the access authorisation is granted to the key that sent the access authorisation information to the locking device—i.e. in particular the aforementioned second key—such that granting of access authorisation can be verified. This is preferably a one-time access authorisation for the, in particular second, key. The granting of the access authorisation comprises the activation of the actuator in order to transfer the driver to the rotatable state.

Denying the access authorisation and/or granting the access authorisation may be a routine that is automatically executed by the system after step c. as part of the commissioning method.

Before step c., in particular after step a, the method may comprise the following step:
wirelessly sending from the device to the key a configuration message that a locking device is to be configured. This configuration message contains the information or is to be evaluated by the key to the effect that a locking device is to be configured. Based on this configuration message, it is preferably provided that the key activates the locking device electronics accordingly, such that it sends its identifier to the key and/or that the locking device electronics carry out step c. This may be followed in particular by the denial of the access authorisation and/or the granting of the access authorisation.

The locking device used as part of the method preferably has a housing and an insert. The insert comprises a stator and the rotor. The stator is preferably fastened to the housing in a form- and/or force-fitting manner. The rotor is rotatably supported in the stator. The fact that the stator and the housing are designed in two parts means that the stator can be inserted into different housings. This means that the housing can also be replaced on site if it proves to be unsuitable for installation or non-functional. This increases the effectiveness of commissioning.

The insert preferably comprises the locking device electronics and the actuator.

The actuator can be used to unlock the previously locked rotor such that the rotor and the driver connected to the rotor are rotatable. Additionally or alternatively, the rotor can be coupled to the driver by means of the actuator.

The locking device is preferably free of mechanical coding. This means that the rotatability of the driver depends only on an electronic access authorisation of the user. A large number of locking devices therefore have the same internal structure, such as a key channel, key removal barrier, electrical contacts, coupling element for the driver or similar. Accordingly, the key can be free of mechanical coding.

The disclosure further comprises a system for commissioning a locking device at a location, in particular the locking device described above. The advantageous configurations and subclaims described as part of the method advantageously apply correspondingly as part of the system.

The system comprises the electromechanical locking device with the locking device electronics, the actuator and the driver. The locking device is designed in particular as described above. Furthermore, the locking device is designed to carry out method steps, in particular steps a., b. and c. according to the method described above. In particular, the method steps described in connection with the locking device are carried out in the locking device.

The system also comprises the key, in particular the described key. The key is in particular designed to carry out the method steps according to the method described above, which are described in connection with the key.

The system preferably comprises a computer program product for execution, in particular also storage, on a device, in particular the device described above. The computer program product is designed to carry out the method steps of the described method on the device. This in particular executes the method steps on the device that were previously described in connection with the device.

The system can comprise the device and/or the computing unit.

### BRIEF DESCRIPTION OF THE DRAWINGS

The disclosure will be explained in more detail below on the basis of exemplary embodiments, in which is shown:

FIG. 1 a system according to the disclosure for carrying out the method according to the disclosure in accordance with all exemplary embodiments,

FIG. 2 an insert of the locking device of the system according to the disclosure from FIG. 1,

FIG. 3 an exploded representation of the insert from FIG. 2,

FIG. 4 method steps of the method according to the disclosure in accordance with all exemplary embodiments,

FIG. 5 further method steps of the method according to the disclosure in accordance with a first exemplary embodiment,

FIG. 6 a schematic representation of locations of a lock system used in the method according to the disclosure in accordance with all exemplary embodiments, and

FIG. 7 further method steps of the method according to the disclosure in accordance with a second exemplary embodiment.

### DETAILED DESCRIPTION OF THE DRAWINGS

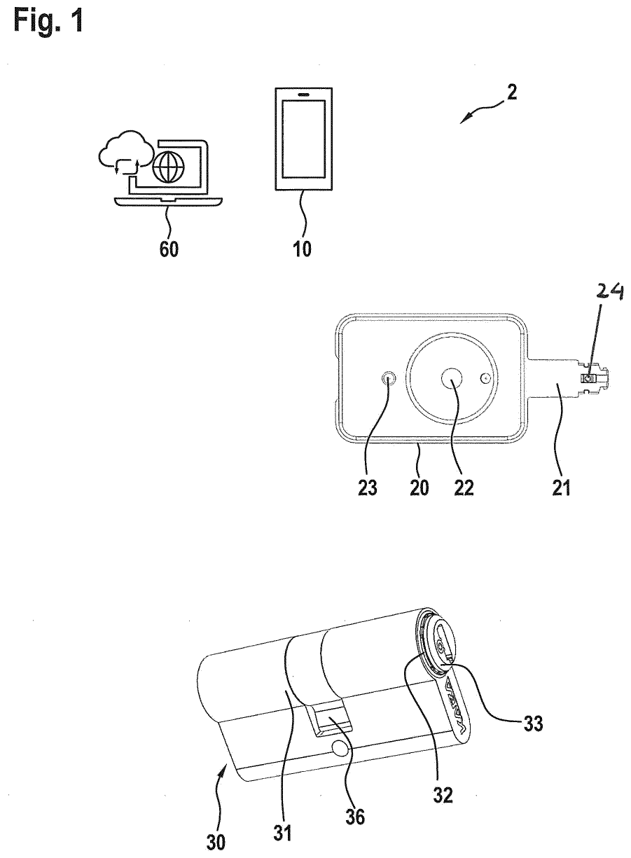

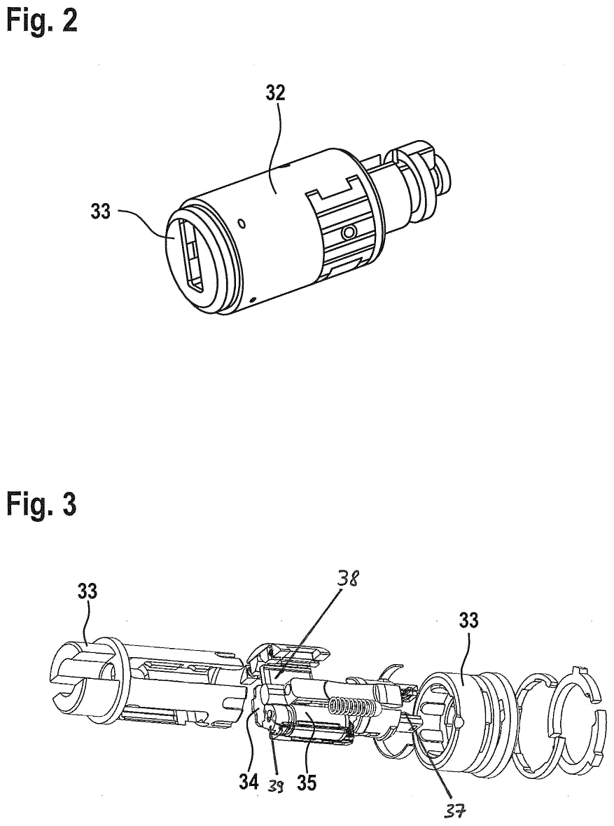

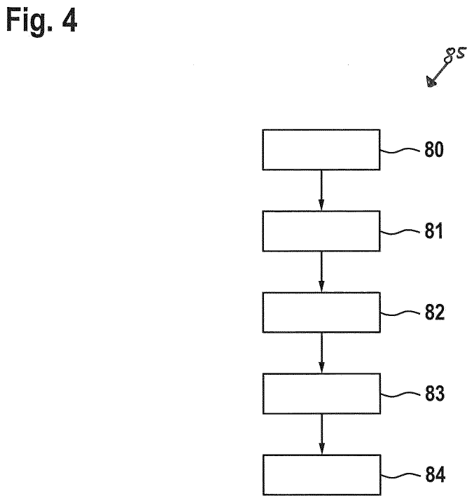

The structure of a system 2 for carrying out a method 1 will be described below purely schematically on the basis of FIGS. 1 to 3. The method 1 will then be explained in more detail on the basis of the schematic representation in FIGS. 4 to 7.

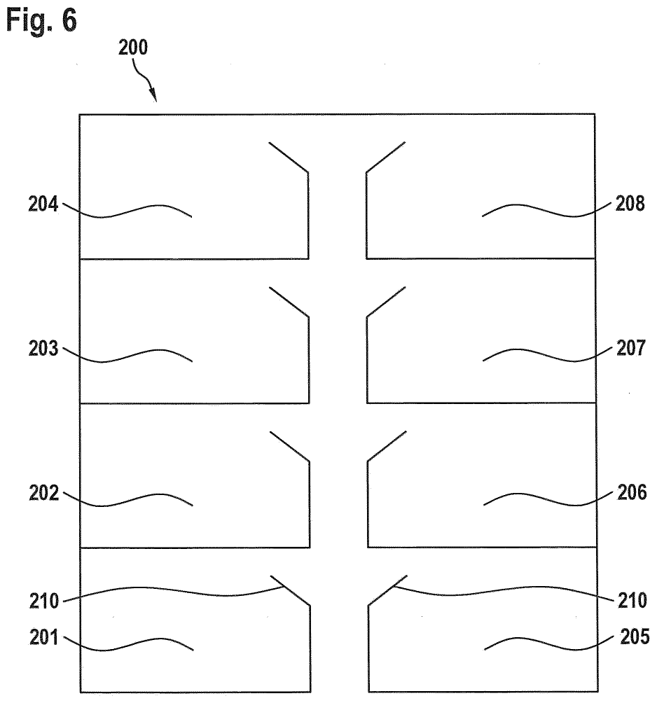

FIG. 1 shows the system 2 purely schematically. It comprises an electromechanical locking device 30, designed here as a lock cylinder. The locking device 30 is inserted into a closure element 210 at a specific location 201-208 (see FIG. 6). Various lock cylinders can be arranged at the locations 201-208 (see FIG. 6) as part of a lock system 200. FIG. 6 shows a location overview plan of the lock system 200 with different locations 201-208, designed as different rooms. Each location 201-208 can be closed by a closure element 210, i.e. a door with a lock. Corresponding locking devices 30 are inserted into the closure elements 210. The locations can be divided into different location regions: For example, locations 201 and 205 are general rooms to which every user should have access and which form a first location region, while only individual users should be granted access to the locations 202-204, 206-208. The locations 202-204, 206-208 form a second location region.

Furthermore, FIG. 1 illustrates that the system 2 comprises a key 20 and a device 10. In addition, a computing unit 60 can also be assigned to the system 2. The computing unit 60 is in particular a server, for example a virtual server in a cloud.

The device 10 is in particular a mobile device, as explained in the general part of the description. The computing unit 60 and the mobile device 10 are designed for data communication, in particular wireless data communication. In this case, the mobile device can communicate with the computing unit 60 via the Internet and/or a telecommunications network. In addition, the mobile device 10 can communicate with the key 20 via a wireless near-field connection with short range, for example BLE or UWB.

The key 20 has a key shank 21 for introduction into the locking device 30. Furthermore, the key 20 has a button 22 for activating a communication connection between the key 20 and the device 10. Appropriate signals indicating the communication connection can be output by means of a light device 23 on the key 20. In addition, the light device 23 can indicate when a method step has been carried out or has failed. Electrical contacts are formed on the key shank 21 as a transmission device 24 in order to transmit data and electrical energy to the locking device 30 and to receive data from the locking device 30. The locking device comprises a corresponding transmission device 37. The key 20 comprises an energy storage device to supply itself and the locking device 30 with electrical energy.

FIG. 1 also illustrates that the locking device 30 has a housing 31. A stator 32, in which a rotor 33 is inserted, is located on the housing 31. The key shank 21 of the key 20 can be introduced into this rotor 33. During operation, i.e. in a configured state of the locking device 30, the rotor 33 can only be rotated by rotating the key 20 if an access authorisation is present. If there is no access authorisation, however, the rotor 33 remains locked. The access authorisation is verified by the key 20 and the locking device 30.

By rotating the rotor 33, i.e. if access authorisation is present, a driver 36 shown, which in the present example is designed as a locking lug, can be rotated. The driver 36 is connected to the rotor 33 in a rotationally-fixed manner, at least when the key 20 is introduced.

Furthermore, locking device electronics 34 are provided. It activates an actuator 35 of the locking device 30 in the configured state if access authorisation is present. By activating the actuator 35 accordingly, the locking device 30 can allow the rotor 33 to rotate. If the rotation of the rotor 33 is permitted, the driver 36 is in a rotatable state. If the rotation of the rotor 33 is prevented, the driver 36 is in a non-rotatable state.

To transfer the rotor 33 and thus the driver 36 from the non-rotatable to the rotatable state, the actuator 35 rotates an asymmetrical blocking element 39. By rotating the blocking element 39, an unlocking movement of a locking bar 38 can be permitted. The locking bar 38 can engage in the stator 32 to lock the rotation of the rotor 33. The rotation of the blocking element 39 allows the locking bar 38 to disengage from the stator 32.

The locking device 30 comprises an electronic identifier ID, which is stored in the locking device electronics 34.

The key 20 is designed without mechanical coding. Therefore, only electronic access authorisation information can be used to determine whether or not the user has authorisation. The key 20 comprises an electronic key identifier.

FIG. 4 illustrates method steps, of which the method steps 80, 81 and 84 are optional. Accordingly, the following can take place as part of the method 1 for commissioning the electromechanical locking device 30 at a location 201-208:
80: Determining an appropriate housing 31: A user 70 (also referred to as an installer) can first select the appropriate housing 31, in particular the housing 31 of a lock cylinder.
81: Inserting the stator 32 and the rotor 33: The stator 32 and rotor 33 are then mounted in the appropriate housing 31, in particular as a joint insert.
82: Introducing the key 20: The key 20 is preferably introduced into the locking device 30 before the locking device 30 is mounted in the closure element 210 (e.g. lock). The locking device electronics 34 can then detect the key and thus carry out step a. according to the disclosure.
83: Triggering a function verification routine: The actuator 35 is activated by the locking device electronics 34 such that it allows the driver 36 to move. This corresponds to step b according to the disclosure. Here, the electrical energy is provided by the key 20 via the transmission devices.
84: Rotating: Using the introduced key 20, the installer 70 can rotate the driver 36 by transmitting torque from the key 20 to the rotor 33 via the key shank 21. This allows the mechanical functioning of the locking device 30 to be verified. If necessary, the driver 36 can be rotated to the required position such that the locking device 30 can be introduced into the closure element 210 and thus mounted therein.

If the locking device 30 can be inserted into the closure element 201 without rotating the driver 36, the installer 70 can first mount the locking device 30 and then verify it by means of steps 82 and 83 (not represented).

The locking device 30 is in a factory state while the method 80 to 84 is carried out. In the factory state, any mechanically matching key 20 can be used to cause the locking device electronics 34 to activate the actuator 35 to unlock the rotor 33. Due to the lack of mechanical coding, this applies to every key 20 whose transmission device 24 can be brought into contact with the transmission device 37 of the locking device. Optionally, generally valid access authorisation information, which is installed on each key 20 by default at the factory, can be verified by the locking device 30.

The fact that the actuator can be activated on site, in particular during or after mounting of the locking device 30 with any mechanically matching key 20, means that the installer 70 can install the locking devices 30 of the lock system 200 very effectively. Here, the installer 70 only has to ensure that the installer 70 installs the locking device 30 that is mechanically matching the closure element 210.

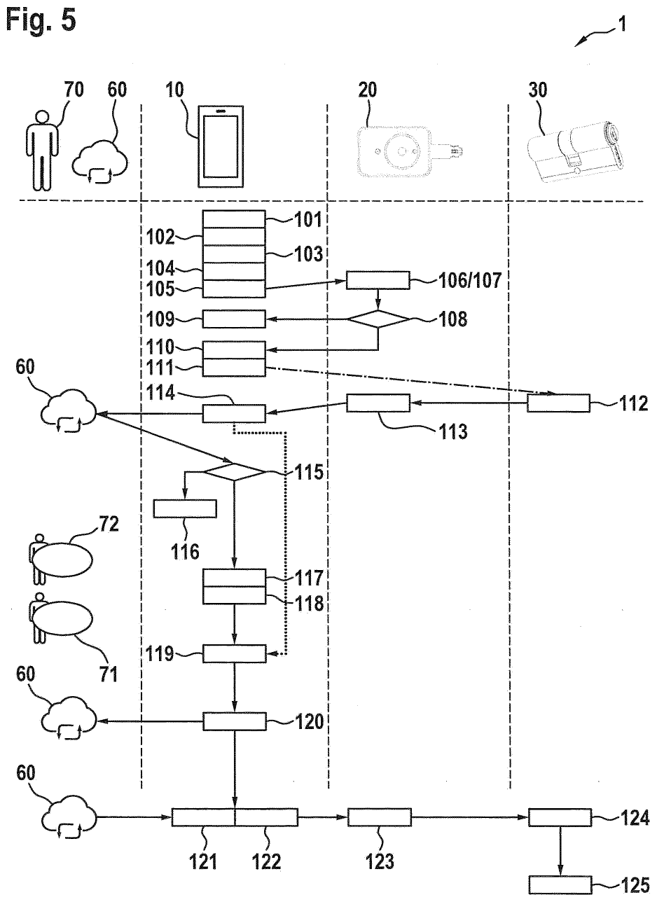

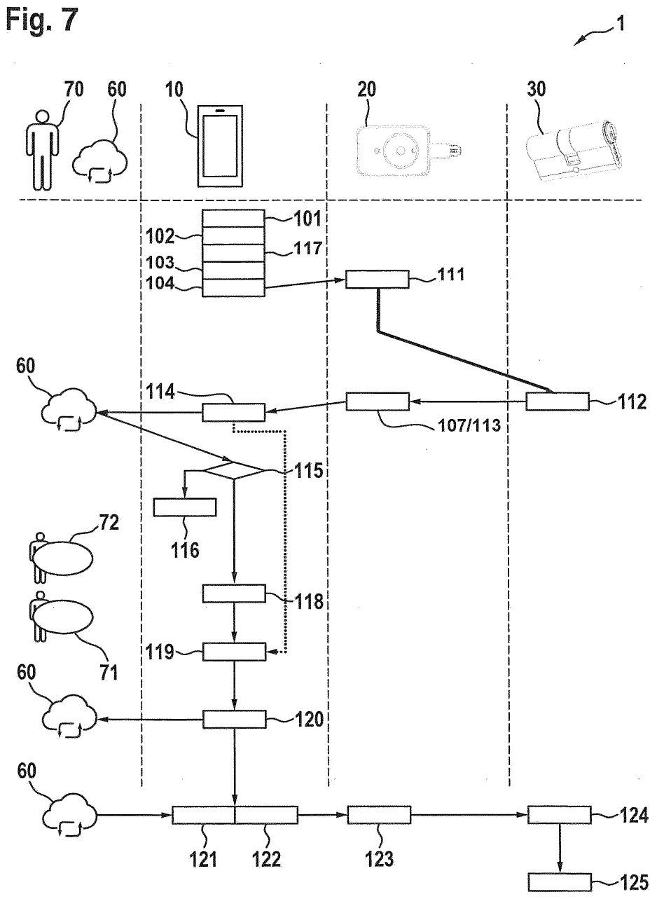

In the factory state, the locking device 30 lacks access authorisation information that will be available for the lock system 200, the location region or the location of the installation during operation. In other words, the steps 82 and 83 are carried out without the system 1 having knowledge of the lock system association of the locking device 30, the location region association of the locking device 30 and the location association of the locking device 30. This association is only subsequently determined by the method steps represented in FIG. 5 or 7. The locking devices 30 in the factory state are thus “bulk goods”.

The missing access authorisation information can relate to a blacklist and/or cryptographic encryption information, in particular an encryption key.

Accordingly, the factory state does not include an access authorisation verification adapted to the lock system 200, the location region or the location. As an access authorisation verification during operation depends on the identifier ID and/or the key identifier, in the factory state there is no access authorisation verification of this type in which the identifier ID and/or the key identifier are included.

Optionally, the installer of the method steps 82, 83, 84 and possibly also of the method steps 80, 81 is a first installer. They can carry out the mechanical installation and function verification quickly and effectively without using the device 10.

Access authorisations may have been allocated for key 20. This means that the same key 20 can be used to unlock a closure element for other locking devices that are already configured if the access authorisation verification is successful.

According to a first exemplary embodiment, FIG. 5 illustrates further steps of the method 1 for commissioning the electromechanical locking device 30 at the location 201-208. FIG. 5 shows purely schematically in a left-hand column method steps which are primarily to be assigned to the installer 70 or the computing unit 60. The installer 70 of FIG. 5 can optionally correspond to a second installer. The second installer can use a different key 20 than the installer, with the keys of the two installers being designed to be mechanically identical.

The second column shows method steps which are primarily to be assigned to the device 10. The third column shows method steps which are primarily to be assigned to key 20. The fourth column shows method steps which are primarily to be assigned to the locking device 30.

As explained in the general part of the description, many of the method steps are optional and do not necessarily have to be carried out.
101: Receiving to start the programme: In this method step, the device 10 receives a corresponding input of the installer 70, such that the programme, in particular computer programme product, is started on the device 10. This also means that a programme that has already been started is called up and thus placed on the operable interface of the device 10.
102: Receiving for user authentication: In this method step, the installer 70 can be authenticated by the device 10 in order to determine whether they are authorised for further method steps. This can be done by entering a password directly on the device 10, for example. However, receiving also means that the device 10 captures biometric data of the installer 70, for example, in order to ensure authentication. This also allows a distinction to be made between the first installer, who is not authorised for the further method steps, and the second installer, who is authorised for the further method steps.
103: Receiving for wireless communication on the device side: In this method step, it can be taken into account that wireless communication between the device 10 and the key 20 and/or between the device 10 and the computing unit 60 only takes place when the installer 70 confirms this by a corresponding input.
104: Receiving for starting the “Commissioning locking device” programme module: In the programme, there may be a module that is explicitly called up in order to subsequently put a new locking device 30 into operation. A user input is required for this.
105: Outputting a request to actuate a button on the key: In this method step, the installer 70 can be prompted to press the button 22 on the key 20 by means of the device 10, for example by means of an indication on the display.
106: Receiving the button actuation on the key 20: In this method step, the corresponding electronics in the key 20 receive the information that the button 22 has been pressed.
107: Verifying the charge state: In particular, after it has been received in step
106 that the button 22 has been pressed, a verification of a charge state of the energy storage device of the key 20 takes place in the key 20.
108: Charge state too low—YES/NO? It is determined in the key 20 whether the charge state of the energy storage device is too low, i.e. below a limit value.
109: Cancellation: If the charge state is too low, the process is cancelled. A corresponding notification is in particular displayed on the device 10, informing the installer 70 that the charge state is too low.
110: Sending the configuration message: However, if the charge state is not too low according to method step 108, the key 20 informs the device 10 of this and a configuration message is sent from the device 10 to the key 20. The content of this configuration message is that a new locking device 30 is to be configured.
111: Outputting information for introducing the key: After the optional sending of the configuration message according to method step 110, a message is preferably output on the device 10 informing the installer 70 that the key 20 is now to be introduced into the locking device 30. For example, a corresponding output is shown on the display of the device 10.

The installer 70 then introduces the key 20 into the locking device 30.
112: Sending the ID: In particular, introducing the key 20 wakes up the locking device electronics 34 and sends an identifier (ID) of the locking device 30 to the key 20.
113: Relaying the ID: The key 20 is connected non-wirelessly to the locking device 30 and receives the identifier in this way. The key 20 then relays the identifier to the device 10 via the wireless communication connection with the device 10.
114: Sending the ID to the computing unit 60: The device 10 can now relay the identifier received in method step 113 to the computing unit 60, although this is not absolutely necessary.
115: ID already assigned—YES/NO? Information can be generated in the computing unit 60 as to whether the identifier of the locking device 30 is already assigned to a location. The computing unit 60 sends this information to the device 10. Based on this information, either method step 116 or 117 is then carried out in device 10.
116: Cancellation: If it turns out that the identifier of the locking device 30 is already assigned to a location, the process is in particular cancelled. The installer 70 is preferably informed of this by a corresponding output on the device 10.
117: Lock system selection: In the next step, a lock system selection can take place on the device 10, in which—as explained in detail in the general part of the description—the installer 70 selects a lock system 200. For this purpose, a lock system user input 72 is made by the installer 70 on the device 10.
118: Receiving a location-specific user input 71: In the next step, the installer 70 performs a location-specific user input 71 on the device 10 such that the device 10 can receive the location-specific user input 71. The location-specific user input 71 in particular takes place directly on the device 10. The exact configuration of this location-specific user input 71 is explained in detail in the general part of the description and applies accordingly to the exemplary embodiment.
119: Assignment: In this method step, the device 10 uses the identifier of the locking device 30 relayed according to method step 113. During the assignment, the device 10 forms an ID location assignment, i.e. a connection between the identifier and the defined location 201-208.

In addition, a connection between the defined lock system 200 and the defined location 201-208 can also take place as part of the assignment 119 by generating an ID lock system assignment. An ID location lock system assignment is preferably generated.
120: Sending the assignment: In this method step, the ID location assignment can be sent from the device 10 to the computing unit 60. Optionally, the ID lock system assignment is also sent to the computing unit 60 or an ID location lock system assignment is sent.
121: Receiving the access authorisation information on the device 10: In this method step, the computing unit 60 sends access authorisation information to the device 20, as explained in the general part of the description. The access authorisation information is based in particular on the location assignment, in particular the ID location assignment, and/or on the lock system assignment, in particular the ID lock system assignment. This means that the access authorisation information is specific to the location or lock system. If the location of the computing unit 60 was known and assigned to a location region or if the computing unit 60 can derive the associated location region from the location information, the access authorisation information can be specific to the location region. The access authorisation information can comprise a blacklist and/or encryption information, in particular an encryption key. The arrow between method steps 120 and 121 indicates the chronological order of the steps in the device 10, namely that the device 10 first sends the assignment in step 120 and then receives the access authorisation information in step 121.
122: Sending the access authorisation information to the key 20: As soon as the device 10 has received the access authorisation information in method step 121, it can send it to the key 20, in particular wirelessly, according to method step 122.
123: Relaying the access authorisation information by way of the key 20: The key 20 receives the access authorisation information from the device 10 and relays it to the locking device 30, in particular while the key 20 is introduced. The key 20 modifies the received encryption information.
124: Receiving the access authorisation information, in particular initially receiving the access authorisation information, on the locking device 30. This corresponds to step c. of the method according to the disclosure. The access authorisation information relayed by the key 20 is received in the locking device 30, in particular the locking device electronics 34, according to method step 124. It is at least partially defined in the locking device 30 which signals a key 20 must or must not send to the locking device electronics 34, such that the actuator 35 can be activated such that the rotor 33 can be rotated by means of the key 20.

In addition to the access authorisation information, other configuration data such as locking device operating data may be received and relayed together with the access authorisation information in steps 121 to 123.
125: Sending a confirmation: After receiving the access authorisation information according to method step 124, the locking device 30 can send a confirmation to the device 10, in particular via the key 20, stating that the access authorisation information has been received accordingly. This is done via the key 20 (not represented).

After step 125, the following steps, optional and not represented, can follow: Because the computing unit 60 knows the key identifier of the key 20 used for configuration, and the identifier, a one-time access authorisation is assigned for the key 20. The system 200 carries out an access authorisation verification and signals the access authorisation. The installer can verify this by rotating the driver, for example. Additionally or alternatively, in particular subsequently, a new access authorisation verification is carried out automatically or after a user input on the device 10, in which case the system 200 comes to the conclusion that the access is to be denied to the key 20. This is displayed visually and/or audibly on the device 10 and/or on the key 20.

According to a second exemplary embodiment, FIG. 7 illustrates further steps of the method 1 for commissioning the electromechanical locking device 30 at the location 201-208. The methods 1 according to the disclosure and the systems 2 of the two exemplary embodiments are identical, with the exception of the differences described below:
101 and 102: as for FIG. 5.
117: According to FIG. 7, the lock system selection already takes place after step 102: A lock system selection can be made on the device 10, in which—as explained in detail in the general part of the description—the installer 70 selects a lock system 200. For this purpose, a lock system user input 72 is made by the installer 70 on the device 10.
103 and 104: After step 117, the optional steps 103 and 104 can follow, as described in connection with FIG. 5.
111: This is followed by step 111. In this exemplary embodiment, step 111 merely describes the introduction of the key 20 into the locking device 30. The key 20 is designed such that it is woken up when it is introduced. Thus in the second exemplary embodiment according to FIG. 7, steps 104 and 105 can be omitted, such that no button actuation on the key 20 is necessary.
112: Sending the ID: In particular, introducing the key 20 wakes up the locking device electronics 34 and sends an identifier (ID) of the locking device 30 to the key 20.
113 with 107: Relaying the ID: The key 20 is connected non-wirelessly to the locking device 30 and receives the identifier in this way. The key 20 then relays the identifier to the device 10 via the wireless communication connection with the device 10.

In this process, the charge state of the energy storage device of the key 20 can also be verified according to step 107. If the charge state is too low, the process is cancelled. A corresponding notification is in particular displayed on the device 10, informing the installer 70 that the charge state is too low.
114 to 116: as for FIG. 5.
118 to 125: as for FIG. 5.

1. A method for commissioning an electromechanical locking device at a location,
wherein the locking device comprises an electromechanical actuator, locking device electronics and a driver, wherein the electromechanical actuator can be activated by the locking device electronics in order to transfer the driver from a non-rotatable to a rotatable state;
and wherein the method comprises the following steps carried out by the locking device:
a. detecting an electronic key,
b. triggering a function verification routine, with the actuator being electrically activated in order to transfer the driver from the non-rotatable to the rotatable state,
wherein the locking device is in a factory state during steps a. and b.,
c. subsequently receiving configuration data, with the configuration data comprising at least one item of access authorisation information, whereby the locking device is transferred from the factory state to a configured state,
wherein the access authorisation information contains location-specific and/or location region-specific and/or lock system-specific encryption information, wherein the locking device in steps a. and b. is designed to be free of location-specific and/or location region-specific and/or lock system-specific encryption information.

2. The method according to claim 1, wherein step b. takes place after an installation of the locking device in or on a closure element, and/or wherein step b. takes place to install the locking device on a closure element.

3. The method according to claim 1, wherein in step b. the function verification routine is triggered independently of a lock system assignment by the key structurally matching the locking device.

4. The method according to claim 1, wherein in step b. the function verification routine is triggered independently of a location region assignment and/or a location assignment of the locking device by the key structurally matching the locking device.

5. The method according to claim 1, wherein step b. takes place without an access authorisation, which depends on an electronic identifier (ID) of the locking device and/or an electronic key identifier and/or on the location, having been verified beforehand.

6. The method according to claim 1, wherein the access authorisation information in step c. comprises location-specific, location region-specific and/or lock system-specific access authorisation information.

7. The method according to claim 1,
wherein the access authorisation information contains a location-specific and/or location region-specific and/or lock system-specific blacklist, wherein the locking device in steps a. and b. is designed to be free of a location-specific and/or location region-specific and/or lock system-specific blacklist.

8. (canceled)

9. The method according to claim 1, wherein the configuration data comprises location-specific and/or location region-specific and/or lock system-specific locking device operating data, wherein the locking device is designed in steps a. and b. to be free of location-specific and/or location region-specific and/or lock system-specific locking device operating data.

10. The method according to claim 1,
wherein a location-specific user input for defining the location takes place by receiving the user input by way of a device before step c.
and/or wherein a lock system selection of a lock system takes place by receiving a lock system user input by way of the device before step c.

11. The method according to claim 10, wherein the location-specific user input and/or lock system user input takes place by selection from selection lists and/or overview plans displayed on a screen of the device or wherein location information for defining the location is newly created during the location-specific user input.

12. The method according to claim 10, wherein, before step c., the device sends the location information obtained by way of the location-specific user input and/or the lock system information obtained by way of the lock system user input to a computing unit and/or receives location-specific and/or lock system-specific access authorisation information from the computing unit.

13. The method according to claim 12,
wherein access authorisation information is sent from the key to the locking device, wherein the key comprises a key shank, wherein the key is introduced with the key shank into the locking device, to send the access authorisation information to the locking device (30), wherein the key has previously received access authorisation information from the device.

14. The method according to claim 1, wherein in step c. the access authorisation information is sent from the key to the locking device,
wherein the key in step a. is a first key,
wherein the key for sending in step c. is a second key,
and wherein the first key and the second key are mechanically identical and/or comprise different authorisations.

15. The method according to claim 1, wherein, after step c., the method comprises the following further step carried out by the locking device and/or the key:
d. denying the access authorisation for the key that sent the authorisation information to the locking device in order to verify the function of the locking device in the configured state.

16. The method according to claim 1, wherein before step c., the method comprises the following step:
wirelessly sending from the device to the key a configuration message that a locking device is to be configured.

17. A system for commissioning a locking device at a location, wherein the system comprises a key with electronics
wherein the system comprises an electromechanical locking device, wherein the locking device comprises an electromechanical actuator, locking device electronics and a driver, wherein the electromechanical actuator can be activated by the locking device electronics in order to transfer the driver from a non-rotatable to a rotatable state, wherein the locking device is designed to carry out the following method steps:
a. detecting the electronic key,
b. triggering a function verification routine, wherein the actuator is electrically activated in order to transfer the driver from the non-rotatable to the rotatable state,
wherein the locking device is in a factory state during steps a. and b.,
c. subsequently receiving configuration data, wherein the configuration data comprises at least one item of access authorisation information, whereby the locking device is transferred from the factory state to a configured state,
wherein the access authorisation information contains location-specific and/or location region-specific and/or lock system-specific encryption information,
wherein the locking device in steps a. and b. is designed to be free of location-specific and/or location region-specific and/or lock system-specific encryption information.

18. The system according to claim 17,
wherein the system comprises a computer program product for execution on a device, wherein the computer program product is designed to carry out the method, wherein a location-specific user input for defining the location takes place by receiving the user input by way of a device before step c., and/or wherein a lock system selection of a lock system takes place by receiving a lock system user input by way of the device before step c on the device.
